(19) United States
(12) Patent Application Publication
(10) Pub. No.: US 2025/0047088 A1
(43) Pub. Date: Feb. 6, 2025

(54) PORTABLE GENERATOR RETRACTABLE POWER CORD

(71) Applicant: J. D. North America Corp., Ontario (CA)

(72) Inventors: Craig Serio, New Berlin, WI (US); Ken Stair, New Berlin, WI (US); David Flegel, Watertown, WI (US)

(21) Appl. No.: 18/920,332

(22) Filed: Oct. 18, 2024

Related U.S. Application Data
(63) Continuation-in-part of application No. 18/628,057, filed on Apr. 5, 2024.
(60) Provisional application No. 63/544,729, filed on Oct. 18, 2023.
(60) Provisional application No. 63/457,874, filed on Apr. 7, 2023.

(51) Int. Cl. H02G 11/02; B65H 75/40; B65H 75/44; B65H 75/48; H01B 7/42

(52) U.S. Cl. CPC H02G 11/02; B65H 75/403; B65H 75/4471; B65H 75/4494; B65H 75/48; H01B 7/423; B65H 2701/34

(57) ABSTRACT

A portable power distribution system is provided that may include a portable generator and one or more retractable power cords in order to simplify the process of storing power cords associated with the system while the portable generator is moved from one location to another. Some or all of the retractable power cords may be removably attached to the portable generator, or some or all of the retractable power cords may be permanently attached to the portable generator. The system may include additional features to optimize performance, including color-coded power cords, a storage compartment, various lighting components, displays to enhance user experience, load shedding features, a power switch associated with each cord, and a cooling system such as an airflow management system. A method of using the system is also provided.

### CROSS REFERENCE TO A RELATED APPLICATION

This application claims the benefit of provisional U.S. patent application 63/544,729, filed on Oct. 18, 2023, and non-provisional U.S. patent application Ser. No. 18/628,057, filed on Apr. 5, 2024, the entire contents of which are hereby expressly incorporated by reference into the present application.

### BACKGROUND OF THE INVENTION

### 1. Field of the Invention

The present invention relates in general to the field of generators. More specifically, the present invention is directed to portable generators configured to be moved from location to location. Even more specifically, the present invention is related to a retractable power cord associated with a portable generator that enables the power cord to quickly and easily be retracted in an organized fashion.

### 2. Discussion of the Related Art

Portable generators are routinely used to provide power to a variety of electronic devices. For instance, portable generators are useful in situations where the main power supply to a given building is interrupted. Similarly, portable generators can be used in remote areas without a standard power supply, or where the power supply is far enough away that it would be inconvenient to use one or more extension cords.

When a portable generator is used, it is wheeled or otherwise moved adjacent to a desired location, after which a power cord associated with the given electronic device is plugged in. In many instances, multiple electronic devices may be plugged into the portable generator. Oftentimes, the multiple electronic devices are spaced from one another, necessitating the use of other cords. In some instances, separate extension cords may not be suitable for use with the portable generator. Even if the separate extension cords are usable with the portable generator, they are separate devices that must be carefully wrapped up or otherwise prepared for storage and transportation.

What is therefore needed is a portable generator that enables a user to move the generator from location to location while also enabling power supply to physically separate electronic devices. What is further needed is a portable generator that has one or more power cords that can quickly and easily be extended and subsequently retracted in an organized fashion within or adjacent to the portable generator.

### SUMMARY AND OBJECTS OF THE INVENTION

By way of summary, the present invention is directed to a portable power distribution system that includes a portable generator and a least one retractable extension cord, and preferably a plurality of retractable extensions cords associated with the portable generator. Such a system enables quick and efficient storage of the extension cords before the portable generator is moved from one location to another.

According to an aspect of the present invention, at least one of the retractable extension cords is removably connected to the portable generator. According to another aspect, at least one of the retractable extension cords is permanently connected to the portable generator. In other embodiments, some of the retractable extension cords are removably connected to the portable generator, whereas others are permanently connected to the portable generator.

Additionally, a storage compartment may be associated with the portable generator. The storage compartment may be configured to receive one or more of the extension cords, as well as any other component associated with the portable generator. For instance, where the extension cords are removably connected to the portable generator, the cord may be retracted or otherwise stored, after which the cord can be inserted into the storage container for future use. Alternatively, the extension cord may be permanently mounted within the storage container, such that the cord can be extended when use is needed, after which it can be retracted back within the storage compartment when use is completed. Further still, the retractable extension cord may have a housing about which the cord is retracted. Such a housing may be mounted within the storage compartment.

According to another aspect of the present invention, cords having different characteristics are provided. For instance, a first extension cord having a first length may be provided, and a second extension cord having a second length may be provided, where the first length is different from the second length. Additionally or alternatively, a first extension cord may be provided that has a first outlet type and a second extension cord may be provided having a second outlet type such that a variety of different devices may be powered by the portable generator. Additionally, the different cords may be color coded to enable a user to quickly and easily understand the differences between different cords.

In yet another aspect of the present invention, additional features may be provided to optimize use of the system. For instance, a plurality of circuit outlets may be provided, in which power to the respective outlets may be prioritized, such that power can be discontinued to outlets of lower priority. Also, a power switch may be associated with one or more of the extension cords, which would enable a user to disable the power supply to a cord without the need to go back to the portable generator itself. Additionally, a cooling system such as an airflow management system may be provided to ensure none of the components of the system overheat. Also, various lighting systems may be provided with the system.

In one configuration of the present invention, the power distribution system includes a portable generator and a retractable cord system. The generator includes a frame and a plurality of wheels. The system includes a housing connected to the portable generator. An electrical cord has a stored length mounted with the housing and a free length having an electrical connector. The system is configured to (i) extend the free length of the cord by removing at least part of the stored length from the housing and (ii) retract at least part of the free length by mounting at least part of the free length with the housing, converting this free length to stored length. In one configuration, the housing is located inside a storage compartment that is attached to the portable generator. The free length of the cord extends through an opening in the storage compartment.

The present invention also includes a method of using a power distribution system. The method includes supplying and orienting a portable generator adjacent to a device requiring power. A retractable extension cord is extended from the generator to the device and provides power to the device. Subsequently, the retractable extension cord is disconnected from the device and retracted. The extension cord is stored with the portable generator, which is moved from one location to another. The cord may also have a load shedding component to help manage the load on the generator.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a perspective view of a portable generator system having a retractable extension cord;

FIG. 2 is a front view of the portable generator system shown in FIG. 1;

FIG. 3 is a back view of the portable generator system shown in FIG. 1;

FIG. 4 is a side view of the portable generator system shown in FIG. 1;

FIG. 5 is another side view of the portable generator system shown in FIG. 1;

FIG. 6 is a cross-sectional side view of the portable generator system shown in FIG. 1; and

FIG. 7 is a cross-sectional side view of the portable generator system shown in FIG. 1.

In describing the preferred embodiment of the invention, which is illustrated in the drawings, specific terminology will be resorted to for the sake of clarity. However, it is not intended that the invention be limited to the specific terms so selected, and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

The present invention is directed to a portable generator that has a built-in retractable extension cord that can be used to power items. This allows a user to use the portable generator without the need to transport, store, and use a separate extension cord. The portable generator may include a specific storage section or housing that enables the retractable extension cord to be retracted and stored relative to the portable generator. Preferably, the extension cord is retracted in an organized fashion to simplify and streamline the storage of the cord, for instance, by wrapping, coiling, or rolling the cord up. The cord may also have a load shedding component.

### 2. Detailed Description of Preferred Embodiments

The present invention is directed to a portable power generator system 20 configured to be moved from location to location to provide power to a variety of devices, including for instance, furnaces, hot water heaters, refrigerators, heaters, personal electronic devices, and the like.

The system 20 may include one or more extension cords 22 extending from the generator. In certain embodiments, multiple extension cords 22 may be used for 120/240, RV 30A and/or 120v configuration. For instance, the system 20 may include at least one extension cord 22 configured to be used with each of a plurality of different types of equipment or other devices having different power, amperage, or voltage needs. In this way, a single system 20 may be transported to any location, with at least one of the extension cords 22 being configured to accommodate each type of equipment needing power. Additionally, or alternatively, a number of extension cords 22 may be provided having a number of different lengths. This would enable a user to select an extension cord 22 having the desired length without having to have excess cord in the way that may occur if the selected cord is too long, or without needing to move the system 20 if the selected cord is too short. The extension cords 22 may be color coded to help expedite a user's selection of the cord, whether it be based on the length needed or the type of cord. In one embodiment, the cord may be at least 20 feet long, e.g., 25 feet in length. Further still, a number of different cords 22 may be provided, for instance, cords 22 having a flat profile, cords 22 having a rounded profile, and cords 22 having any other number of profiles to improve use of the cord 22 as well as optimized storage of the same.

Preferably, the extension cords 22 are configured to enable fast and organized storage of the extension cord 22 on or about the system 20. For instance, the extension cords 22 may be configured to be rolled, coiled, wrapped, or otherwise organized while the cords 22 are moved from an in-use or free position to a storage position. In fact, the system 20 may include a storage compartment 24 configured to receive the cord or cords 22, such that the cords 22 can not only be quickly and easily organized after use is complete, but so that the cords 22 can also be transported with the system 20 itself. This avoids the need for a user to wheel the system 20 and also carry or otherwise separately transport the cords 22.

The retractable extension cord 22 preferably with a spring mechanism may include a housing 26 about which the extension cord 22 is rolled, coiled, wrapped, or otherwise organized. The rolling, coiling, wrapping, or other movement of the cord 22 may be automatically enabled via activation of an operator, such as by pushing a button to start the storage process, or manually enabled such as using a handle that is cranked or otherwise rotated by a user. For instance, the housing 26 may be permanently mounted within the storage compartment 24 such that the extension cord 22 is quickly and easily retracted into the storage compartment 24. In another embodiment, the housing 26 may not be permanently mounted within the storage compartment 24, in which case the extension cord 22 can be retracted about the housing 26, after which it can be moved into the storage compartment 24. The housing 26 may optimize storage of the cord 22 while also protecting the cord 22 from damage during use and transportation. Additionally, the housing 26 may include wheels or a roller to prevent twisting of the cord 22, or to otherwise flatten or properly orient the cord 22 to ensure efficient storage. Other hooks, fasteners, and other configurations, such as a small light tower, may be provided from which the extension cord 22 can be hung, held, retracted, or otherwise engaged with.

Additionally, the system 20 may include a plurality of circuit outlets 28 configured to receive the plurality of extension cords 22. Alternatively, the plurality of extension cords 22 may be permanently installed relative to the system 20, in which case outlets 28 would not be required. In yet another embodiment, some extension cords 22 may be permanently installed relative to the system 20, while outlets 28 are also be provided in order to enable use of permanently installed extension cords 22, as well as extension cords 22 that can temporarily be installed relative to the outlet 28. Any number of different outlets 28 may be provided, and the extension cords 22 can include different outlets or settings to enable any number of different devices to be plugged in and provided with power. The system may also include USB outlets or other ports. In another configuration, one extension cord 22 may include a plurality of outlets 28 on the free end of the extension cord 22 itself. In one embodiment, the outlets 28 are contained in a housing that may also hold other components such as electronics to manage and shed loads from the generator system, e.g., as further described below.

In yet another embodiment of the present invention, one or more of the provided extension cords 22 may include an on/off power switch 30 or other control located at a far end of the extension cord 22 that is not installed relative to the system 20. Stated differently, the extension cords 22 may have a first end mounted to the generator system 20 itself, and a second end that engages with a device needing power, with the second end having an on/off power switch 30 or other control to improve functionality of the system 20 and cords 22. For instance, a user may disable power to the extension cord 22 at the second end, after which the user can plug a device into the second end of the extension cord 22. When the user is ready to enable use of the device, the control 30 can be manipulated, after which power is enabled to the device.

The system 20 may also include a display 27 on or adjacent to the portable generator. The display 27 may show a user information related to the one or more extension cords 22, such as if power is being supplied to an extension cord 22. A variety of other information relating to the system 20 may be shown on the display 27.

Further still, the system 20 may come equipped with any number of different lighting configurations. For instance, the system 20 itself may come equipped with lighting around the system 20 and adjacent to outlets 28 to help facilitate installation of the cords 22 relative to the outlets 28. Additionally, one or more of the cords 22 may also have lighting configurations to help prevent tripping hazards, and to assist in wrapping up or cleaning up the cords 22 once use is completed. The cords 22 may also come equipped with lights that change to indicate different operating characteristics, for instance, the cords 22 light up when a device is plugged in, and power is provided from the system 20.

Additionally, the system 20 and/or the storage compartment 24 may be equipped with a cooling system 40, such as an airflow management system, to prevent overheating of the system 20, the cord 22, and any other components. When power is provided through the extension cord 22, heat may be produced, and overheating must be prevented. In one configuration, the cooling system 40 includes a fan 42. The fan 42 may be located within a storage compartment 24 with the storage compartment having vents 46 to allow for air flow through the storage compartment 24. In another embodiment, the profile of the cord 22 may be configured to enable a staggered roll pattern that allows for an air gap.

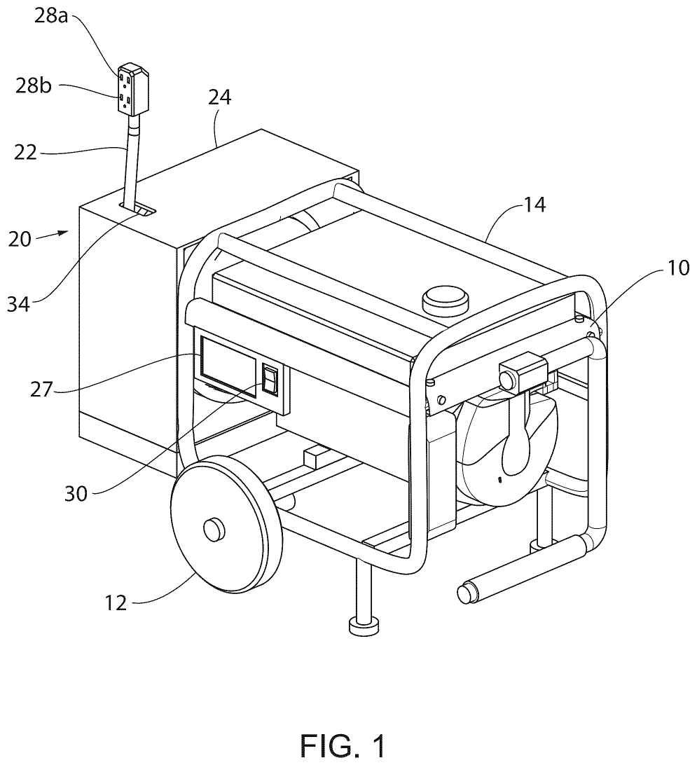

FIG. 1 illustrates one configuration of the present invention. As shown in FIG. 1, a portable generator 10 includes a frame 14 and a plurality of wheels 12. The portable generator 10 includes a retractable extension cord system 20. The system 20 includes a retractable extension cord 22 housed or stored within a storage compartment 24. In this configuration, the storage compartment 24 is attached to the portable generator 10 and/or the frame 14. The storage compartment 24 may be permanently or removably connected to the portable generator 10. In another configuration, the storage compartment 24 may be formed within the generator 10 itself.

The retractable extension cord 22 may be an electrical cord having one or more electrical connectors. In the system 20, the one or more cords 22 are electrically connected to the portable generator 10. This electrical connection between the one or more cords 22 and the generator 10 may be permanent or configured to be disconnected, e.g., via a plug. As shown in FIG. 1, the electrical connectors are female outlets 28a, 28b located at the free end of the cord 22. In this configuration, the cord 22 has two outlets 28a, 28b extending from the storage compartment 24. The multiple outlets may incorporate a load shedding feature, as further described below.

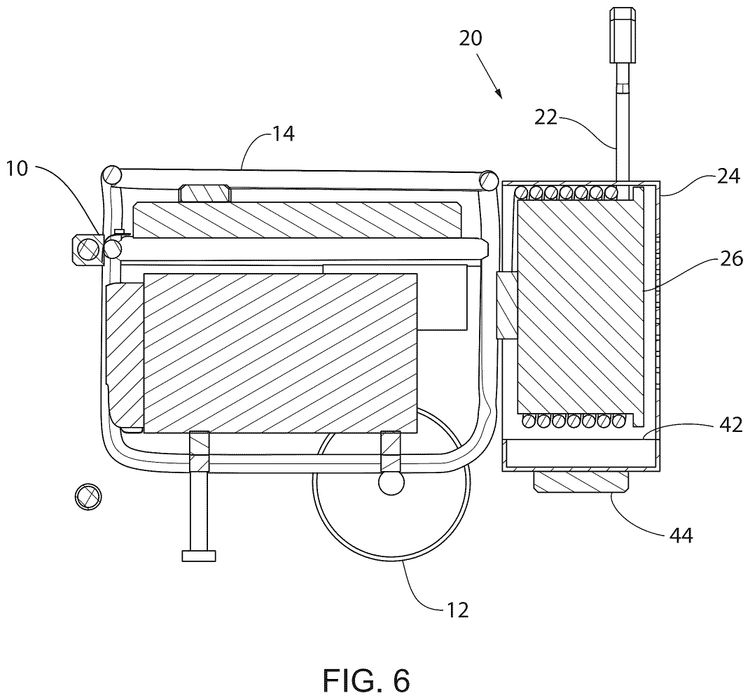

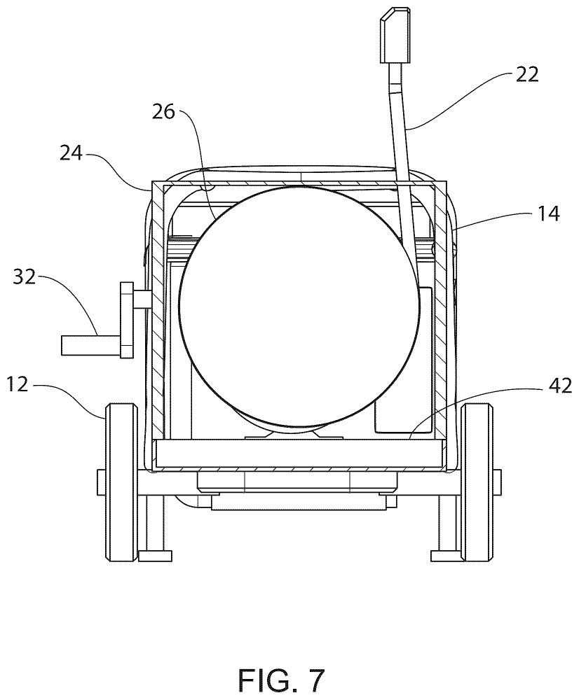

As shown in FIGS. 6 and 7, the system 20 includes a housing 26 that is located within the storage compartment 24. The extension cord 22 is mounted with the housing 26. In this configuration, the housing 26 is a wheel and the cord 22 is wrapped around or coiled around the circumference of the wheel. In another configuration, the housing 26 may be hooks.

The extension cord 22 has a stored length, which is the length of the extension cord 22 that is mounted with the housing 26. In other words, the stored length is the portion of the extension cord 22 that is un-used and housed within the storage compartment 24. The extension cord 22 additionally has a free length. In this configuration, the free length includes two outlets 28a, 28b. The free length extends through an opening 34 in the storage compartment 24 and is substantially unbound by any structure.

The system 20 is configured for the free length of the cord 22 to extend from the housing 26 and subsequently retract back onto the housing 26. Specifically, the free length of the cord 22 is extended by removing at least part of the stored length of the cord 22 from the housing 26. In this configuration, the stored length of the cord 22 is removed from the wheel and extended out of the storage compartment 24. Further, the free length of the cord 22 is retracted by pulling back at least part of a free length of cord 22 into the storage compartment 24 and re-mounting this part of the cord 22 with the housing 26, effectively converting this part of free length of the cord 22 to stored length of cord 22.

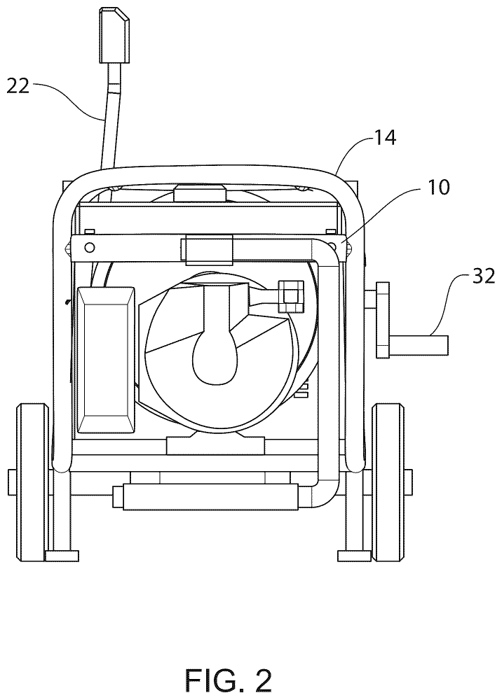

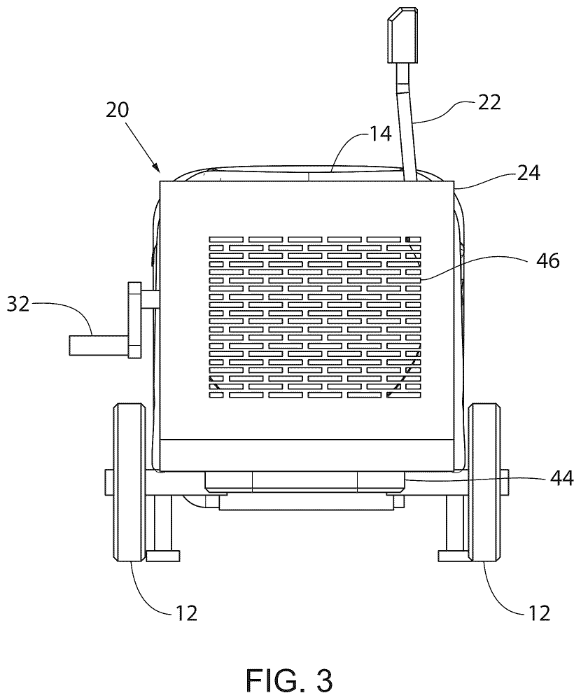

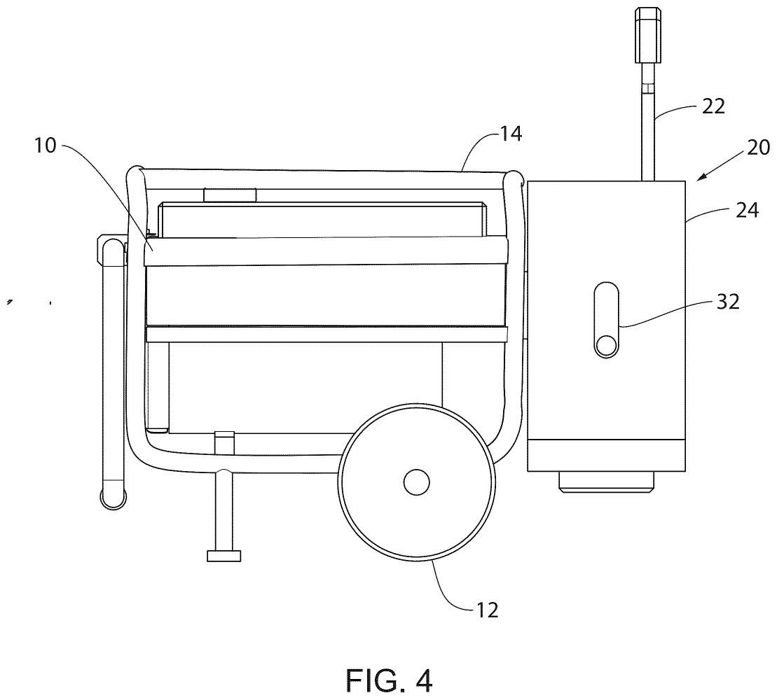

The system 20 may also include an operator that is configured to control the extension and retraction of the electrical cord 22. As shown in FIGS. 2-4, the operator may be a handle 32. Rotation of the handle 32 in one direction may extend the extension cord 22 from the housing 26, and rotation of the handle 32 in the opposite direction may retract the extension cord 22 to be mounted with the housing 26. Rotating the handle 32 may rotate the housing 26 to cause the subsequent extension and retraction. In another configuration, the operator may be a turnable knob. In yet another configuration, the operator may be a button that causes a spring mechanism to allow for extension and retraction without manual rotation by the user.

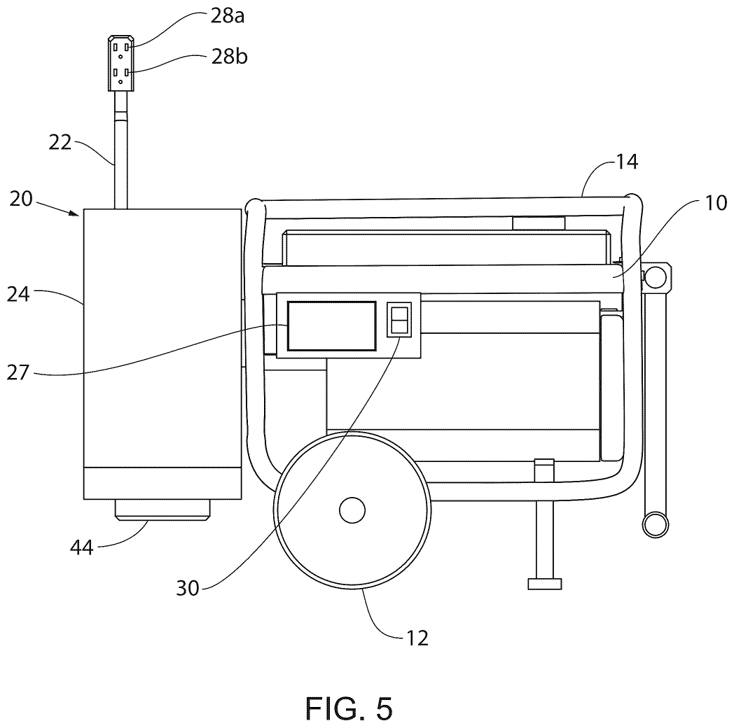

As shown in FIG. 5, a display 27 and switch 30 are located on the generator 10 of this configuration. The switch 30 may control the power supplied to the extension cord 22 and/or the outlets 28a, 28b. In other words, the switch 30 may terminate power to the cord 22 when turned off and supply power to the cord 22 when turned on. In another configuration, a plurality of switches 30 may be included to control power to a plurality of extension cords 22 and/or a plurality of outlets 28. The display 27 may provide a user an indication of the operation of the system 20. For example, the display 27 may show if power is being supplied to the extension cord 22.

As shown in FIGS. 6 and 7, the system 20 also includes a cooling system 40. The cooling system 40 includes a fan 42 located within the storage compartment 24. The fan 42 blows air toward the electrical cord 22 to prevent the cord 22 from overheating. The fan 42 includes an air intake 44 that is in fluid communication with the exterior air. The air intake 44 may protrude out from the storage compartment 24. The cooling system 40 also may include vents in the storage compartment 24 allowing air flow out of the storage compartment 24. Thus, the fan 42 pulls air from the intake 44 and blows it onto the extension cord 22 and out of the vents 46. In another configuration, insulation may also be included with the storage compartment 24 to maintain a desired temperature of the extension cord 22 and the system 20.

The present invention is also directed to a method of using the system 20 and components described above. The method includes supplying and orienting a portable generator, as described above, next to a device requiring power. The retractable extension cord is extended from housing to the device, where the cord is electrically connected to the device. Once connected, power is provided through the extension cord and to the device. The method further comprises disconnecting the retractable extension cord from the device. Once disconnected, the retractable extension cord is retracted back on the housing. The cord may be retracted by activation of an operator, such as rotating a handle or pushing a button. With the cord retracted, the extension cord may be stored with the housing and/or within the storage compartment. The portable generator may then be moved to a new location with the extension cord stored.

The method may further include a system having a plurality of extension cords. Each power cord may have its respective power switch. Each respective power switch may be activated and/or deactivated to control the power supplied to each extension cord.

In one configuration, the method may also include cooling the extension cord with a cooling system. Specifically, a fan may be initiated to blow air onto the extension cord. Air may flow from the air intake of the fan, through the fan, toward the extension cord, and through vents in a storage compartment.

In another configuration, the method includes a load shedding feature, as described further below.

In addition to the retractable extension cord features, the system may also be equipped with load shedding. Such a system advantageously allows for power supply to certain outlets to be discontinued in a desired order in the event that a maximum power output is reached or surpassed before a surge is blown or the device otherwise fails. For instance, circuits or other electronics housed near or within the cord system may be arranged in a specific order or assigned a specific priority to allow a user to arrange or plug in the devices in a desired order, such that power to the more important devices is maintained and less important loads are shed. The load shedding concept is further described in U.S. application Ser. No. 18/628,057, which is incorporated in full. Additionally, the system may include a display showing the load, for instance, a LED or other light display, a display having various characters, letters or numbers, or any other number of displays that enable a user to understand how much load the system is supplying. Of course, the display could similarly show any information that may be relevant to operation of the system.

The present invention advantageously allows for load shedding, that is, for power supply to certain outlets to be discontinued in a desired order in the event that a maximum power output is reached or surpassed before a surge is blown or the device otherwise fails. For instance, the circuits may be arranged in a specific order that allows a user to plug in the devices and/or retractable extension cords in a desired order, such that power to the more important devices is maintained.

In one embodiment, the generator has a plurality of circuit outlets. The outlets may be located on the generator itself, on one or more retractable extension cords, or both. The outlets may include any number of different outlet types, including single receptacle outlets, duplex receptacle outlets, twist and lock outlets, and any other different type of outlets as known to those having ordinary skill in the art. In the typical scenario, power is initially provided to all of the outlets. In the event that the total power provided to the outlets exceeds a designated maximum power output, power to one or more of the lowest priority outlets is discontinued. For example, should the generator include three outlets, power to the lowest priority outlet would be discontinued while power to the medium and highest priority outlets would be maintained. In the event that the maximum power output is again exceeded, power to the medium priority outlet two can also be discontinued, while power to the highest priority outlet one is maintained. In this way, a user has the ability to prioritize power supply to various components, so that in the event that a maximum power output for a given portable generator is exceeded, the entire portable generator is not shut down, but instead less important components are depowered automatically without the need for the user to physically perform any tasks.

While the system may include the portable generator described above where the load shedding occurs on an outlet-by-outlet basis, the portable generator could similarly shed loads in groups. For instance, the outlets may be grouped into a first plurality of outlets and a second plurality of outlets. This would enable a user to designate a group of outlets that are of higher or lower priority. For instance, all of the high priority devices may be plugged into the first plurality of outlets, whereas all of the low priority devices may be plugged into the second plurality of outlets. This would enable multiple devices to be depowered simultaneously once the designated maximum power output is met or surpassed, in which case the entire second plurality of outlets would be depowered. Further still, the portable generator may be toggled between modes where power is discontinued on an outlet-by-outlet basis, or power is discontinued for a plurality of outlets simultaneously. In yet other embodiments where duplex outlets are used, power to both outlets may be discontinued simultaneously if a maximum power output is met or surpassed, otherwise power to one of the two duplex outlets may initially be discontinued, after which power to the other of the two duplex outlets may be discontinued if the maximum power output is met or surpassed a second time.

The system may also include a power strip having a plurality of outlets. The power strip may be plugged into a portable generator or connected directly to the retractable extension cord. The power strip includes multiple circuit outlets like those described above for the portable generator. Again, the circuit outlets allow a user to prioritize which outlets (and in turn the devices plugged into those outlets) such that power is maintained for the highest or higher priority devices while power is discontinued to lower priority outlets for lower priority devices if a threshold power supply level is exceeded.

Further still, the system may be equipped with various visual indicators to assist with use of the system. For instance, the system 20 may include a display, text, color coding, a number system, arrows, and the like that help a user understand the order in which the outlets are prioritized. The visual indicators may for the load shedding may be incorporated into the display showing the function of the retractable extension cord. This would help to make it easy for a first-time user to understand the order in which devices should be plugged in to ensure high-priority devices are supplied with power over lower priority devices.

The outlets may be arranged in a straight line, with one end being the highest-priority outlets, with the other end being the lowest-priority outlets. Where the outlets are shed in groups, a first grouping of outlets may be located on one side of the system along with other text, images, or visual indicators to designate high priority outlets, and a second grouping of outlets on the second side of the system along with other text, images, or visual indicators to designate low priority outlets. Further still, the visual indicators may not be static, but rather can change. For instance, LED lights may be used to show which of the outlets are being supplied with power, and which of the outlets are no longer powered. In addition to visual indicators, the system may also be equipped with audio indicators to notify a user that power has been discontinued to one or more of the circuits. The system may also communicate information wirelessly, for instance to a Smartphone or computer application, to a website, or to other devices that would enable a user to quickly and easily understand when power has been discontinued to one or more circuits.

Additionally, the system may include other features, such as a start button, a reset button, an LED outlet on indicator, and a programming module. The start button enables the system to be powered on, and the reset button allows the system to be reset. As described above, the LED outlet on indicator provides a user with visual indication of which outlets are currently powered on, for example using green LED lights for outlets that are powered “on” and red LED lights for outlets powered “off”. Additionally, the programming module allows a user to control operation of the system. This can be done remotely, for instance, using Bluetooth.

All the disclosed embodiments are useful in conjunction with providing portable power supply to multiple devices in an organized manner. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials but could be fabricated from virtually any suitable materials. Moreover, the individual components need not be formed in the disclosed shapes, or assembled in the disclosed configuration, but could be provided in virtually any shape, and assembled in virtually any configuration. Further, although the various components are described herein as being physically separate modules, it will be manifest that any of the components may be manufactured together or later assembled with one another. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A portable power distribution system comprising:
a portable generator; and
at least one retractable extension cord associated with the portable generator.

2. The portable power distribution system of claim 1, wherein at least one of the retractable extension cords is removably connected to the portable generator.

3. The portable power distribution system of claim 1, where at least one of the retractable extension cords is permanently connected to the portable generator.

4. The portable power distribution system of claim 1, wherein the at least one retractable extension cord comprises:
a first extension cord having a first length; and
a second extension cord having a second length.

5. The portable power distribution system of claim 1, further comprising a housing configured to receive the at least one extension cord when retracted.

6. The portable power distribution system of claim 5, wherein the housing is located within a storage compartment connected to the portable generator.

7. The portable power distribution system of claim 1, further comprising a first circuit outlet and a second circuit outlet;
wherein the portable generator has a designated maximum power output;
wherein power to the first outlet is maintained when the designated maximum power output is reached; and
wherein power to the second outlet is terminated when the designated maximum power output is reached.

8. A method of using a portable power distribution system, comprising the steps of:
supplying power to a portable generator;
orienting the portable generator next to a device requiring power;
extending a retractable extension cord to the device;
providing power to the device;
disconnecting the retractable extension cord from the device;
retracting the retractable extension cord;
storing the retractable extension cord; and
moving the portable generator from one location to another location.

9. The method of claim 8, wherein the retractable extension cord is permanently mounted to the portable generator.

10. The method of claim 8, further comprising storing at least part of the retractable extension cord on a housing located within a storage compartment connected to the portable generator.

11. The method of claim 8, further comprising the steps of:
activating a power switch associated with at least one extension cord; and
deactivating a power switch associated with at least one extension cord.

12. The method of claim 8, further comprising cooling the retractable extension cord with a cooling system.

13. The method of claim 8, further comprising assigning a priority value to a plurality of outlets connected to the retractable extension cord; and
terminating power to one of the plurality of outlets based on a maximum available power while continuing to supply power to another of the plurality of outlets.

14. The method of claim 8, further comprising activating an operator to initiate the retracting of the retractable extension cord.

15. A power distribution system comprising:
a portable generator comprising a frame and a plurality of wheels;
a retractable cord system comprising
a housing connected to the portable generator,
an electrical cord comprising a stored length mounted with the housing and a free length, the free length comprising an electrical connector;
wherein the retractable cord system is configured to (i) extend the free length of electrical cord by removing at least part of the stored length of electrical cord from the housing and (ii) retract the free length of electrical cord by mounting at least part of the free length of electrical cord with the housing.

16. The power distribution system of claim 15, wherein the housing is located inside a storage compartment that is attached to the portable generator.

17. The power distribution system of claim 15, wherein the housing is a wheel, and the stored length of the electrical cord is wrapped around the wheel.

18. The power distribution system of claim 15, further comprising an operator that is configured to extend and retract the free length of the electrical cord.

19. The power distribution system of claim 15, wherein the operator is selected from a group consisting of a handle, a button, and a knob.

20. The power distribution system of claim 15, further comprising a cooling system that comprises a fan located inside a storage compartment.
